(19) United States
(12) Patent Application Publication
(10) Pub. No.: US 2026/0019753 A1
(43) Pub. Date: Jan. 15, 2026

(54) LOUDSPEAKER AND METHOD FOR SPREADING A SOUND

(71) Applicant: POWERSOFT S.P.A., SCANDICCI FIRENZE (IT)

(72) Inventor: CLAUDIO LASTRUCCI, LASTRA A SIGNA FI (IT)

(21) Appl. No.: 19/264,373

(22) Filed: Jul. 9, 2025

(30) Foreign Application Priority Data
Jul. 12, 2024 (IT) 102024000016303

(51) Int. Cl. H04R 9/06; H04R 9/02; H04R 9/04

(52) U.S. Cl. CPC H04R 9/06; H04R 9/025; H04R 9/045; H04R 9/046

(57) ABSTRACT

A loudspeaker, includes: a coil, configured to generate a magnetic field along a longitudinal axis; a ferromagnetic circuit including: a central core, around which the coil is wound, and an outer core located at the side of the coil and separate from the central core so as to define a gap, wherein the coil and the ferromagnetic circuit constitute a fixed working unit; a magnet, located in the gap and movable inside the gap along a movement direction responsive to the magnetic field generated by the coil; a radiator which is operatively coupled to the magnet, wherein the magnet and the radiator constitute a movable working unit; a guide system including a flexible part constituting a compliant mechanism, connected to the movable working unit and to the fixed working unit, the flexible part having a plurality of deformable joints and a plurality of rigid connecting portions, the deformable joints being interposed between the rigid connecting portions so as to guide the magnet along the movement direction by elastically deforming the flexible part.

### FIELD OF THE INVENTION

This invention relates to a loudspeaker and to a method for spreading a sound.

### BACKGROUND OF THE INVENTION

Generally speaking, loudspeakers comprise an electromechanical transducing system to convert a variable electrical signal into a mechanical movement of a radiator in order to generate a sound wave. These transducing systems have a magnetic element which is integral with the fixed parts of the sound diffuser and a magnetic element which is connected to the radiator to move it; in particular, the movable magnetic element moves under the action of the magnetic field generated by the integral magnetic element.

In this context, there are two types of electromechanical transducing systems. In the more common system, known as “moving coil” system, the integral magnetic element is a permanent magnet, while the movable magnetic element is a coil; the coil is energized by the electric signal to be transduced and moves in response to the interaction with the magnetic field generated by the permanent magnet. One example of a moving coil system is described in patent document U.S. Pat. No. 5,014,323A. Alternatively, in what is known as a “moving magnet” system, the integral magnetic element is a fixed coil, while the movable magnetic element is a magnet; the fixed coil is energized by the electric signal and the moving magnet moves in response to the magnetic field generated by the coil. One example of a moving magnet system is described in patent document EP2550724, in the name of the present Applicant.

In loudspeakers, there is a need to guide the rectilinear motion of the components so as to ensure that the movement is as precise as possible and rigid along the directions orthogonal to the directions of the motion. Moreover, it is preferable for the “compliance” to be higher along the direction of the motion than along the directions orthogonal thereto. For this purpose, loudspeakers comprise centring (or guide) systems.

Patent document U.S. Pat. No. 5,014,323A describes a moving coil system comprising a centring system, called a spider; such centring systems, however, tend to break easily, creating the need for frequent repairs.

Patent document 102022000026061, in the name of the present Applicant, describes a moving magnet or moving coil system comprising a guide system between the moving part and the fixed part of the loudspeaker. The guide system consists of an element which is closed on itself to form a ring, configured to roll between the components in response to their relative movement; this guide system may be noisy, however. In effect, a very strongly felt need, especially in loudspeakers of the moving magnet type, is to obtain movement which is as silent as possible.

The patent document EP4207809A1, in the name of the present Applicant, discloses a moving magnet loudspeaker, provided with a guide system comprising a plurality of retaining bands, which are configured to allow a movement along a single axis and to prevent transverse displacement. In particular, each retaining band includes a plurality of flattened portions, connected to one another by angled portions. During the movement of the magnet, the flattened portions bend, while the angled positions accommodate the resulting deformation.

To facilitate such bending, the flattened portions are provided with a plurality of triangular cut-outs, whereas the angled portions are free of such cut-outs, and therefore are comparatively more rigid. However, the guide system based on the retaning bands does not provide sufficient stifness in the transverse direction, since the flattened portions themselves, when bending, undergo deformation not only anlong the inteded direction of movement of the magnet, but also transversely, thereby reducing the system's ability to effectively constrain undesired degrees of freedom. Moreover, in the case of moving magnet loudspeakers, it is important that the loudspeaker be compact, lightweight and relatively inexpensive to manufacture.

### BRIEF SUMMARY OF THE INVENTION

The aim of this invention, therefore, is to provide a loudspeaker and a method for spreading a sound to overcome the above mentioned disadvantages of the prior art.

In particular, the aim of this invention is to provide a loudspeaker and a method for spreading a sound which are capable of ensuring a high degree of rigidity along the directions orthogonal to the preferential direction of the motion.

A further aim of this invention is to provide a loudspeaker which is compact, lightweight and inexpensive.

These aims are fully achieved by the loudspeaker and method for spreading a sound of this disclosure, as characterized in the appended claims.

The loudspeaker comprises a coil, configured to generate a magnetic field along a longitudinal axis.

The loudspeaker comprises a ferromagnetic circuit. The ferromagnetic circuit includes a central core. The coil is wound around the central core. In particular, the coil has a plurality of windings wound around the longitudinal axis and surrounding the central core. The central core is aligned with the longitudinal axis.

The ferromagnetic circuit comprises an outer core. The outer core is located at the side of the coil. The outer core at least partly surrounds the coil.

The outer core is separate from the central core so as to define a gap.

Preferably, the coil and the ferromagnetic circuit constitute a fixed working unit.

The loudspeaker comprises a magnet. The magnet is located in the gap and is movable inside the gap along a movement direction responsive to the magnetic field generated by the coil. In particular, the gap extends along the movement direction. Thus, the magnet moves along the movement direction inside the gap.

In an embodiment, the movement direction and the longitudinal axis are parallel or coincide with each other, or the movement direction and the longitudinal axis are perpendicular to each other. Thus, the direction of the magnet and the longitudinal axis around which the coil is wound may be parallel or perpendicular to each other.

The loudspeaker comprises a radiator. The radiator is operatively coupled to the magnet so that a movement of the magnet along the movement direction corresponds to an oscillation of the radiator along the movement direction, so as to generate pressure waves. In particular, when the movement direction and the longitudinal axis of the coil are parallel or coincide with each other, the oscillation of the radiator is parallel with the longitudinal axis (or along the longitudinal axis).

Preferably, the magnet and the radiator constitute a movable working unit. The loudspeaker comprises a guide system, configured to constrain the magnet to move along the movement direction. In other words, the guide system is configured to constrain (guide) the longitudinal (reciprocating) movement.

In particular, the guide system includes a flexible part. The flexible part constitutes a compliant mechanism. The term compliant mechanism is used to mean a mechanical system, whose movement occurs by elastic deformation of the mechanism itself. A compliant mechanism is configured to be flexible at specific points (hereinafter called deformable joints), while maintaining its rigidity in other parts of it (hereinafter called rigid connecting portions).

The flexible part is connected to the movable working unit in a first connecting zone and to the fixed working unit in a second connecting zone. The flexible part has a plurality of deformable joints and a plurality of rigid connecting portions. The deformable joints are more compliant than the rigid connecting portions. In other words, by deforming, the joints allow the rigid connecting portions to move relative to each other.

Preferably, the deformable joints are zones of the flexible part which are thinner than the rigid connecting portions.

The deformable joints are interposed between the rigid connecting portions (and vice versa) so as to guide the magnet along the movement direction by elastic deformation of the flexible part. The deformable joints are configured to deform in response to the movement of the magnet along the movement direction.

That way, the flexible part controlledly guides the movement of the movable working unit relative to the fixed working unit. When the magnet of the movable working unit moves, the deformable joints deform, while the rigid connecting portions remain rigid and move relative to each other along the movement direction so as to allow the movable working unit to move longitudinally. The flexible part prevents (that is to say, is configured to prevent) the movable working unit (in particular, the magnet) from moving along directions orthogonal to the movement direction.

Thus, a compliant mechanism is made up of a combination of flexible parts (the joints) and rigid parts (the connecting portions) so as to obtain motion transmission by elastic deformation.

Differently from the guide system disclosed in patent document EP4207809A1, filed in the name of the same Applicant, the flexible part according to the present invention does not operate by bending, as is the case with the retaining bands of EP4207809A1, but rather exclusively by tension and compression between rigid connecting portions.

In response to the movement of the magnet, the rigid connecting portions remain substantially undeformed (i.e., rigid), such that the mutual distance between all internal points of each rigid connecting portion remains unchanged during the movement of the magnet. In other words, the rigid connecting portions of the flexible member behave as rigid bodies. By contrast, in EP4207809A1, the mutual distance between points of the flattened portion changes during the movement of the magnet, as said portion deforms by bending.

Preferably, one or more of the rigid connecting portions of the plurality of rigid connecting portions extend along a direction transverse to the movement direction. In other words, the rigid connecting portions extend in a direction in which movement is to be prevented, i.e., transversely to the direction of movement.

In particular, the rigid connecting portions have a main extension transverse to the direction of movement. More specifically, each rigid connecting portion extends transversely to the movement direction between a first end and a second end, and the joints of the plurality of deformable joints may be located at the ends of the rigid connecting portions. The main extension of the rigid connection portion may be substantially equal to the extension of the magnet along the same direction.

More particularly, the rigid connecting portions have a width defined along a first transverse direction, wherein the first transverse direction is perpendicular to the direction of movement; the rigid connecting portions have a depth defined along a second transverse direction, wherein the second transverse direction is perpendicular to both the direction of movement and the first transverse direction. For each rigid connection portion, the width is greater than the depth. In particular, the width of the rigid connection portion is substantially equal to (or comparable with) the overall width of the loudspeaker. The loudspeaker has a transverse dimension or width defined along the first transverse direction, and the width of the rigid connection portion is substantially equal to (or comparable with) said transverse dimension or width of the loudspeaker.

Preferably, the compliant mechanism is made of homogeneous material, that is to say, the joints and the rigid portions are made of the same material. Therefore, the flexible part allows obtaining precise movements, without friction and mechanical backlash. In effect, compared to solutions comprising an element which rolls or slides between the components, the flexible part is more silent.

In an embodiment, the loudspeaker comprises a plurality of magnets. In particular, the plurality of magnets comprises the magnet. Each of the plurality of magnets is movable along a respective movement direction parallel to the longitudinal axis. Each of the plurality of magnets is located in the gap. In other words, the loudspeaker comprises a plurality of gaps; each magnet is located in a respective gap. The plurality of magnets is connected to the radiator so as to define, together with the radiator, the movable working unit of the loudspeaker.

For each magnet of the plurality of magnets, the guide system comprises a flexible part, connected to the respective magnet in the first connecting zone and to the fixed working unit in the second connecting zone. Each flexible part is configured to guide the magnet of the plurality of magnets along the respective movement direction.

The flexible parts may be connected to each other (directly or indirectly). In an embodiment, the flexible part is a monolithic body; in other words, the flexible part is made as one piece.

Preferably, the flexible part is made of plastic material/polymeric material or in any case of a polymeric material which is capable of resisting cyclic stress due to deformation. Preferably, the flexible part of made of acetal resin. The flexible part may be injection moulded, or cut by laser, water, numerical control or in other ways.

In an example, the plurality of rigid connecting portions have a corresponding plurality of rigid bodies. In other words, each rigid connecting portions defines a rigid body. The rigid body may be elongated along a main direction, preferably transverse to the direction of movement of the magnet. The rigid body is configured to remain substantially undeformed upon application of a force. In other words, the rigid body is substantially non-deformable upon application of a force. The rigid bodies are connected to each other by a deformable joint of the plurality of deformable joints. The joints are configured to bend or flex upon application of a force. Upon movement of the magnet along the movement direction, the deformable joints are configured to deform, while the rigid bodies maintain their shape. In an example, the first connecting zone includes an upper connecting zone and a lower connecting zone.

In one embodiment, with respect to a plane that divides the loudspeaker in half transversely to the direction of movement, the upper connecting zone is located in a first half-space, and the lower connecting zone is located in a second half-space (opposite the first); the upper and lower connecting zone are positioned on opposite sides of the loudspeaker with respect to said transverse plane.

In particular, with respect to the plane that divides the loudspeaker transversely, the upper and lower connecting zones are arranged in an asymmetric configuration relative to said plane.

In particular, the upper connecting zone and the lower connecting zone are spaced apart along a direction transverse to the longitudinal axis and/or to the movement direction, and are located at different heights along the movement direction.

The plurality of joints may comprise a first joint, located in proximity to the upper connecting zone. The plurality of joints may comprise a second joint, located in proximity to the lower connecting zone. The plurality of joints may comprise a third joint. The third joint may be located in proximity to the second connecting zone.

The plurality of joints may comprise a fourth joint and a fifth joint.

The plurality of rigid connecting portions may comprise a first rigid connecting portion, a second rigid connecting portion and a third rigid connecting portion.

The first rigid connecting portion may extend transversely to the movement direction between the first joint and the fourth joint. The second rigid connecting portion may extend transversely to the movement direction between the second joint and the fifth joint.

The third rigid connecting portion may be interposed between the first rigid connecting portion and the second rigid connecting portion. The third rigid connecting portion is connected to the first rigid connecting portion at the fourth joint. The third rigid connecting portion is connected to the second rigid connecting portion at the fifth joint. The third rigid connecting portion is connected to the fixed working unit of the loudspeaker by the second connecting point.

Thus, the flexible part deforms at the first, second, third, fourth and fifth joints but remains rigid at the first, second and third rigid connecting portions. It is noted that the term connection may denote any means of attaching two elements to each other; for example, the connection may be a mechanical connection (a pressure or shape coupling) or it may be a glued connection. In particular, the flexible part has a width. The width is defined at the upper connecting zone and the lower connecting zone, perpendicularly to the movement direction. The flexible part has a depth, defined perpendicularly to the movement direction and to the width. Preferably, the width of the flexible part is greater than its depth. In other words, the flexible part extends predominantly at the upper connecting zone and at the lower connecting zone.

More specifically, a ratio between the length and the depth is greater than 2. Preferably, the ratio between the length and the depth is less than 12.

Thus, the greater the depth is, the greater the rigidity of the flexible part along the axis of extension of the depth of the flexible part. Thus, the torsion of the flexible part, towards or away from the movement axis, is minimized. In effect, it is preferable to have high rigidity of the magnet motion along the directions orthogonal to the movement direction.

In addition or alternatively, it is noted that if there is a plurality of flexible parts, it is preferable to obtain the rigidity of the movement towards and away from the longitudinal axis by connecting them to each other directly or indirectly. In particular, the flexible parts are connected to each other, directly or indirectly, to form a polygon, more specifically, a quadrilateral. For example, the flexible parts are connected to each other (directly or indirectly) to form a polygon of flexible parts, where the polygon lies in a plane perpendicular to the movement direction. The polygon formed by the flexible parts may constitute a body which is rigid along the directions orthogonal to the movement direction and may be movable along the movement direction.

It is also noted that, at rest, (when no forces are applied to the magnet), the first rigid connecting zone and the second rigid connecting zone are disposed parallel to each other. Preferably, the third rigid connecting zone has the shape of a parallelepiped.

In an embodiment, the plurality of joints (and of rigid connecting portions) is configured to create a kinematic mechanism which approximates a linear Watt guide. In other words, the flexible part constitutes a linear Watt guide. In the linear Watt guide, the upper connecting point and the first joint coincide, and the lower connecting point and the second joint coincide. In this case, the joints are not configured to deform but rotate, like pins, about the upper connecting zone and lower connecting zone. In the linear Watt guide, the first rigid connecting zone is pivoted at the upper connecting point so as to be able to rotate like a rigid body about the upper connecting point; the second rigid connecting zone is pivoted at the lower connecting point so as to be able to rotate like a rigid body about the lower connecting point. The third rigid connecting zone is connected to the first rigid connecting zone and to the second rigid connecting zone by the fourth and the fifth joints, respectively. In this case, the fourth joint and the fifth joint do not deform but rotate like pins.

As the magnet moves, the upper connecting zone and the lower connecting zone move in response to the movement of the magnet (the connecting zones being connected, directly or indirectly, to the magnet), thereby causing the first rigid connecting portion, the second rigid connecting portion and the third rigid connecting portion to move, thanks to the joints (in the case of the linear Watt guide, the pins) which allow their movement. Since the rigid connecting portion is connected, by the second connecting point, to the fixed working unit of the loudspeaker, through the joints and the first rigid connecting point and the second rigid connecting portion, the magnet fixed to the deformable part is constrained to move only along the movement direction, while it is prevented from moving along axes perpendicular to the movement direction.

In an example, the third rigid connecting portion is connected to the outer core of the ferromagnetic circuit at the second connecting zone; preferably, relative to the second connecting zone, the third rigid connecting portion is free to rotate about an axis through the second connecting zone.

In an embodiment, the third rigid connecting portion comprises a plurality of arms. Each arm extends transversely to the movement direction (and to the longitudinal axis, in the case where the movement direction and the longitudinal axis are perpendicular to each other). In particular, the plurality of arms is configured to allow the third rigid connecting zone to deform along the movement direction, responsive to the movement of the magnet along the movement direction.

In particular, the plurality of arms comprises a first arm and a second arm. Each arm extends between two ends. The first arm and the second arm are connected to each other at the ends of them. In particular, the arms are each disposed parallel to one another.

The third rigid zone may comprise a plurality of slits to allow the third rigid connecting zone to deform when subjected to a force applied to it along the movement direction. The slits may extend in a direction transverse to the movement direction.

In an embodiment, the first arm comprises a sixth joint, a seventh joint and a fourth rigid connecting portion, interposed between the sixth joint and the seventh joint; the second arm comprises an eighth joint, a ninth joint and a fifth rigid connecting portion, interposed between the eighth joint and the ninth joint.

The first arm and the second arm are configured to deform at the sixth, seventh, eighth and ninth joints responsive to the magnet moving along the movement direction.

In an embodiment, the guiding device includes a support structure configured to connect the magnet to the flexible part. The support structure is configured to move along the movement direction responsive to the magnet moving along the movement direction. In particular, the support structure is connected to the flexible part at the first connecting zone (in particular at the upper connecting zone or the lower connecting zone), to the first rigid connecting portion and to the second rigid connecting portion of the flexible part.

In an embodiment, the support structure comprises a housing. The magnet is located in the housing of the support structure. That way, the structure and the magnet move together as one.

In another embodiment, the support structure may comprise one or more corner elements. Each corner element is configured to connect a pair of magnets to each other. In particular, the corner elements are interposed between the magnets of the plurality of magnets so as to connect them to form a polygon (or quadrilateral, if there are four magnets).

Each magnet has a first extent, where the first extent is transverse to the movement direction. Each magnet has a first extent between a first end and a second end; each corner element is configured to connect an end (first or second) of a magnet to an end (first or second) of the adjacent magnet. Each corner element is configured to connect a pair of flexible parts to each other. In particular, the corner elements are interposed between the flexible parts of the plurality of flexible parts so as to connect them to form a polygon of flexible parts (or quadrilateral, if there are four flexible parts).

In particular, each corner element is configured to connect a first connecting zone (in particular, the upper connecting zone) of a flexible part with the connecting zone (in particular, the lower connecting zone) of the adjacent flexible part.

In an embodiment, the support structure is configured to connect the magnet to the first rigid connecting zone and to the second rigid connecting zone of the flexible part (at the first connecting point, that is, at the upper connecting point or the lower connecting point).

The loudspeaker may comprise an actuating part. The actuating part is configured to connect the magnet to the radiator, so that a movement of the magnet along the movement direction, corresponds to a movement of the radiator along the same direction (or sense) or, preferably, in the opposite direction (or sense).

In particular, the actuating part may be connected to the magnet by the support structure. For this purpose, the actuating part may be connected to the magnet by the corner element.

In an embodiment, the loudspeaker comprises a plurality of actuating parts. The corner elements may be interposed between the actuating parts of the plurality of actuating parts to form a polygon of actuating parts (in particular, there are four actuating parts, so the actuating parts form a quadrilateral). This disclosure also provides a linear actuator. The linear actuator comprises a coil, configured to generate a magnetic field along a longitudinal axis. The linear actuator comprises a ferromagnetic circuit. The ferromagnetic circuit includes a central core, around which the coil is wound. The ferromagnetic circuit includes an outer core located at the side of the coil and at least partly surrounding the coil. The outer core is separate from the inner core so as to define a gap. The coil and the ferromagnetic circuit constitute a fixed working unit. The linear actuator comprises a magnet, located in the gap and movable inside the gap along a movement direction responsive to the magnetic field generated by the coil. The magnet constitutes a movable working unit. The gap extends along the movement direction.

The loudspeaker comprises a guide system, configured to constrain the magnet to move along the movement direction, where the guide system includes a flexible part constituting a compliant mechanism.

The flexible part is connected to the movable working unit in a first connecting zone and to the fixed working unit in a second connecting zone; the flexible part has a plurality of deformable joints and a plurality of rigid connecting portions. The deformable joints are interposed between the rigid connecting portions so as to guide the magnet along the movement direction by elastic deformation of the flexible part.

Generally speaking, the flexible part may be made according to one or more of the features described herein.

This disclosure also provides a method for spreading a sound. The method comprises a step of providing a coil and a ferromagnetic circuit; the ferromagnetic circuit includes a central core, around which the coil is wound, and an outer core located at the side of the coil and at least partly surrounding the coil. The outer core is separate from the central core so as to define a gap, where the coil and the ferromagnetic circuit constitute a fixed working unit.

The method comprises a step of providing a magnet, located in the gap, and a radiator operatively coupled to the magnet. The magnet and the radiator constitute a movable working unit.

The method comprises a step of generating a magnetic field along a longitudinal axis via the coil, and moving the magnet in the gap along a movement direction responsive to the magnetic field generated. The method comprises a step of causing the radiator to oscillate along the movement direction responsive to the movement of the magnet so as to generate pressure waves. The gap extends along the movement direction. The method comprises a step, via a guide system, of guiding the movement of the magnet along the movement direction, where the guide system includes a flexible part constituting a compliant mechanism. The flexible part is connected to the movable working unit in a first connecting zone and to the fixed working unit in a second connecting zone. The flexible part has a plurality of deformable joints and a plurality of rigid connecting portions. The deformable joints are interposed between the rigid connecting portions.

The step of guiding the magnet along the movement direction is carried out by the flexible part by elastic deformation of the flexible part.

In an example, the step of providing the magnet includes providing a plurality of magnets comprising the magnet, where each magnet is connected to the radiator to define, together with the radiator, the movable working unit; for each magnet of the plurality of magnets, the guide system comprises a flexible part, connected to the respective magnet at the first connecting point and the method comprises a step of moving each magnet along the respective movement direction, the step of guiding including a step of guiding the movement of the respective magnet along the movement direction via the respective flexible part.

In an example, the first connecting zone includes an upper connecting zone and a lower connecting zone; the plurality of joints comprises a first joint, a second joint, a third joint, a fourth joint and a fifth joint; the plurality of rigid connecting portions comprises a first rigid connecting portion, a second rigid connecting portion and a third rigid connecting portion.

The first joint is located in proximity to the upper connecting zone, the second joint is located in proximity to the lower connecting zone and the third joint is located in proximity to the second connecting zone. The first rigid connecting portion extends transversely to the movement direction between the first joint and the fourth joint, the second rigid connecting portion extends transversely to the movement direction between the second joint and the fifth joint.

The third rigid connecting portion is connected to the first rigid connecting portion at the fourth joint, to the second rigid connecting portion at the fifth joint, and the third rigid connecting portion is connected by the second connecting point to the fixed working unit of the loudspeaker.

In an embodiment, the third rigid connecting portion comprises a plurality of arms, each arm extending transversely to the movement direction. The plurality of arms comprises a first arm and a second arm, connected to each other at their ends. The first arm comprises a sixth joint, a seventh joint and a fourth rigid connecting portion, interposed between the sixth joint and the seventh joint.

The second arm comprises an eighth joint, a ninth joint and a fifth rigid connecting portion, interposed between the eighth joint and the ninth joint. In an example, the second connecting zone comprises a pair of connecting zones. The third joint comprises a pair of joints, where the pair of connecting zones is interposed between the joints of the pair of joints. The third rigid connecting portion comprises a central portion, connected to the fixed working unit of the loudspeaker in the pair of connecting zones and movable relative to the first arm and the second arm by deforming the pair of joints. In particular, in the step of guiding, the first arm and the second arm deform at the sixth joint, the seventh joint, the eighth joint and the ninth joint, and the central portion deforms at the pair of joints responsive to the magnet moving along the movement direction.

In an example, the guiding device includes a support structure, configured to connect the magnet to the first rigid connecting portion and to the second rigid connecting portion, and in the step of guiding, the support structure moves along the movement direction responsive to the magnet moving along the movement direction.

### BRIEF DESCRIPTION OF THE DRAWINGS

This and other features will become more apparent from the following description of a preferred embodiment, illustrated by way of non-limiting example in the accompanying drawings, in which:

FIGS. 1A-1D illustrate a flexible part according to one or more of the features described in this disclosure;

FIG. 2 illustrates a loudspeaker according to one or more of the features described in this disclosure;

FIGS. 3A-3G illustrate the loudspeaker of FIG. 2 according to one or more of the features described in this disclosure;

FIGS. 4A and 4B illustrate a ferromagnetic circuit and a coil according to one or more of the features described in this disclosure;

FIG. 5 illustrates the loudspeaker of FIG. 2 according to one or more of the features described in this disclosure, in an exploded view;

FIGS. 6A and 6B illustrate a loudspeaker according to one or more of the features described in this disclosure;

FIG. 6C illustrates a magnet of a loudspeaker according to one or more of the features described in this disclosure;

FIGS. 7A-7D illustrate possible variants of a flexible part according to one or more of the features described in this disclosure.

### DESCRIPTION OF EXAMPLE EMBODIMENTS

The numeral 1 in the drawings denotes a loudspeaker.

The loudspeaker 1 comprises a coil 301C, configured to generate a magnetic field along a longitudinal axis X. In particular, the coil 301C is wound around the longitudinal axis X. The loudspeaker 1 comprises a ferromagnetic circuit which includes a central core 301A. The central core 301A has a central portion 301Aa which extends along the longitudinal axis X and around which the coil 301C is wound. The central core 301A has a lateral portion 301Ab. The lateral portion 301Ab of the central core 301A is disposed so as to surround the coil 301C on the opposite side with respect to the central portion 301Aa. The ferromagnetic circuit includes an outer core 301B located at the side of the coil 301C and at least partly surrounding the coil 301C.

In particular, the central portion 301Aa of the central core 301A is aligned with the longitudinal axis X; the lateral portion 301Ab of the central core 301A surrounds the coil 301C and is disposed at least partly around the longitudinal axis X. The outer core 301B may be separate from the central core 301A along the longitudinal axis X, or along a transverse axis perpendicular to the longitudinal axis X.

The outer core 301B is separate from the central core 301A so as to define a gap T; more specifically, the outer core 301B is separate from the lateral portion 301Ab of the central core 301A so as to define a gap T.

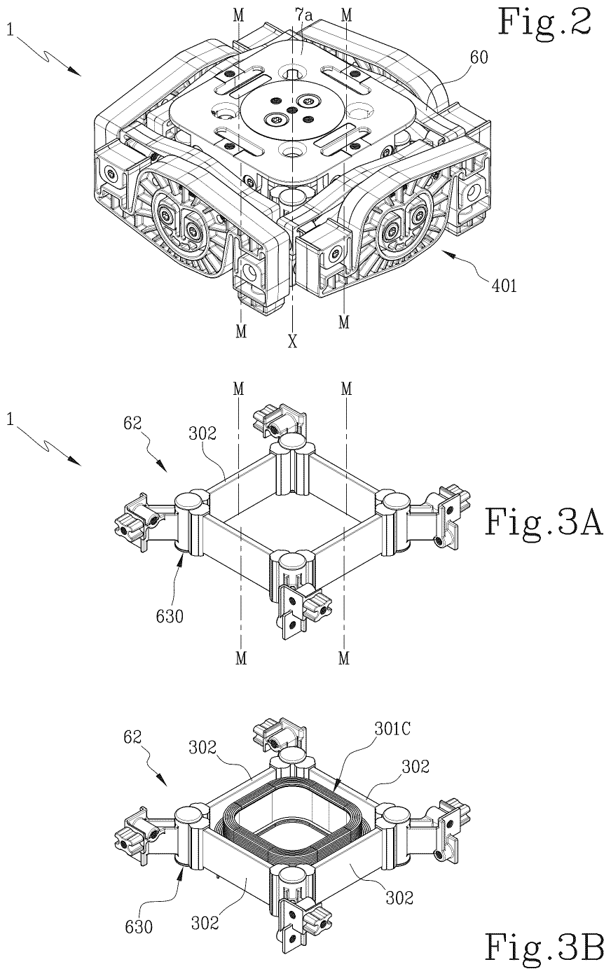

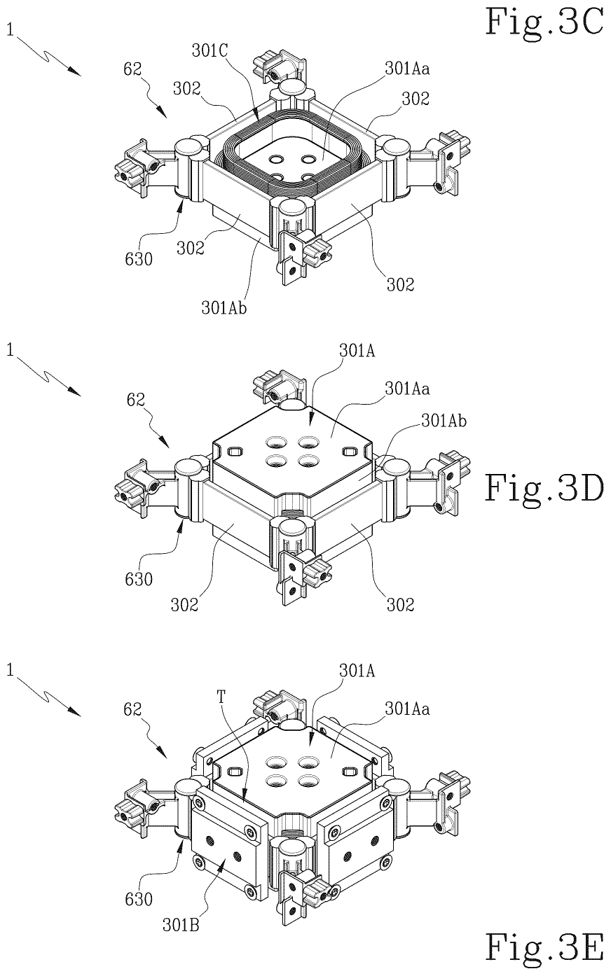

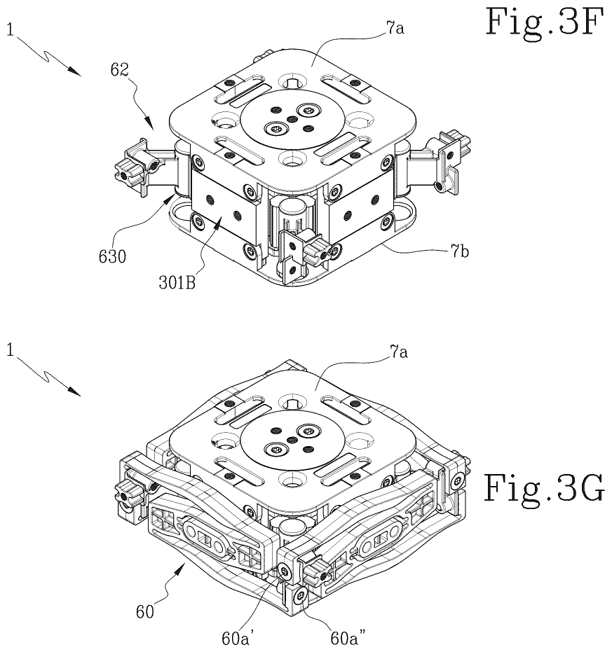

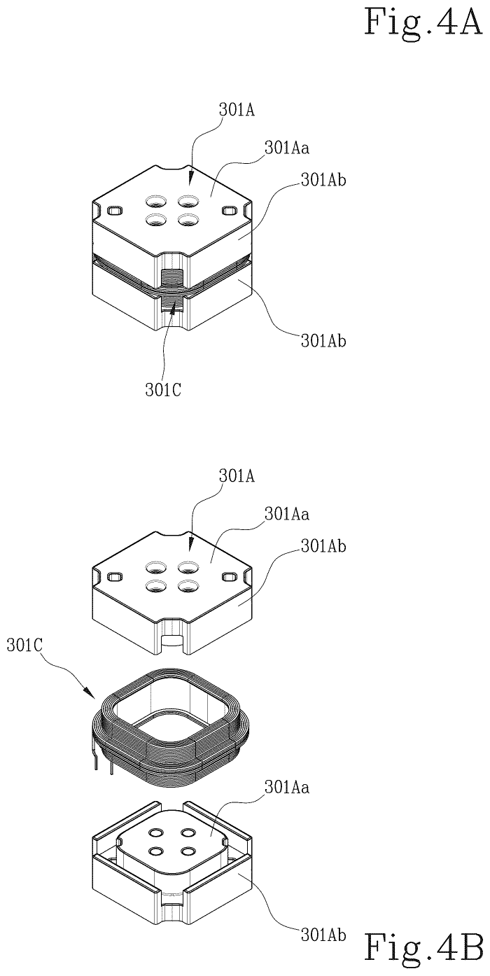

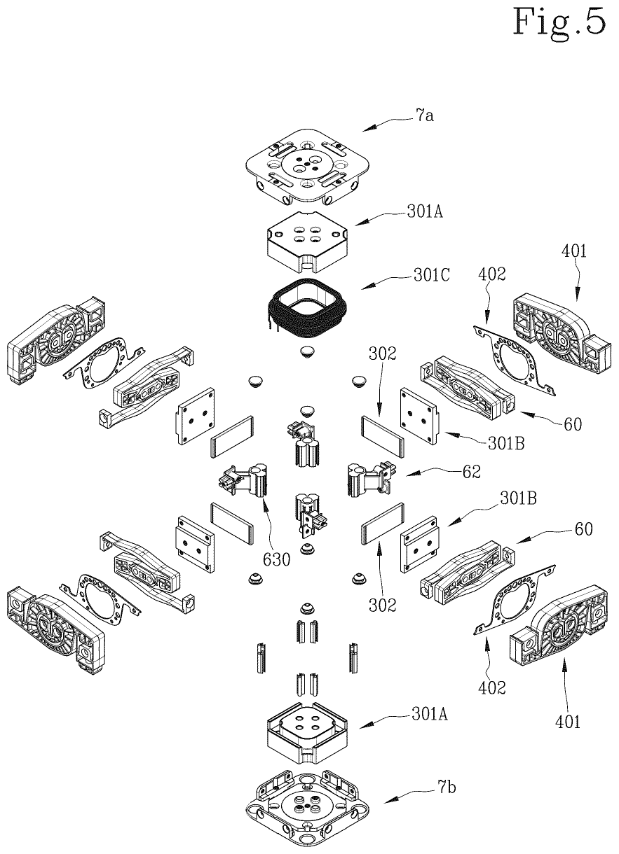

In an embodiment, illustrated for exemplary purposes only in FIG. 2, the outer core 301B is separate from the central core 301A along a transverse direction, perpendicular to the longitudinal axis X.

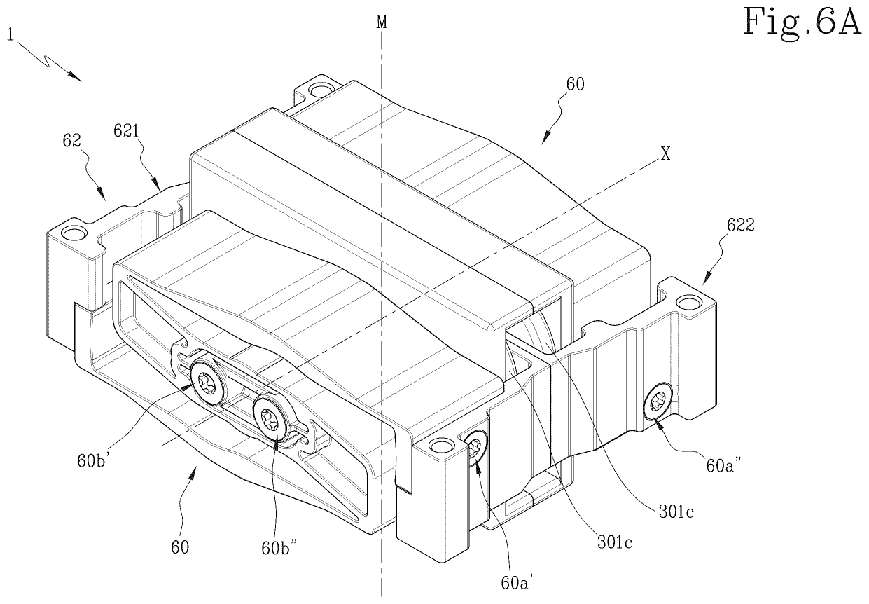

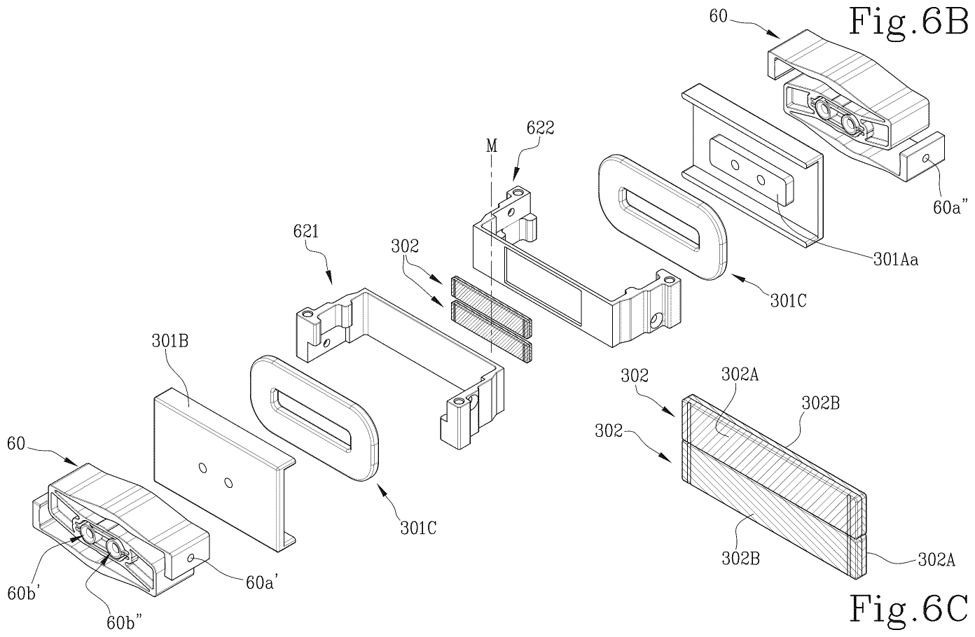

In an embodiment, illustrated for exemplary purposes only in FIGS. 6A and 6B, the outer core 301B is separate from the central core 301A along a longitudinal direction defined by the longitudinal axis X.

The central core 301A may be divided into a first half-shell and a second half-shell. The two half-shells are aligned with each other along the longitudinal axis X.

In an example, illustrated for example in FIGS. 6A and 6B, one between the first half-shell and the second half-shell defines the outer core 301B for the other between the first half-shell and the second half-shell (and vice versa). Thus, one between the first half-shell and the second half-shell is separate from the other between the first half-shell and the second half-shell (and vice versa) so as to define a gap T.

In an embodiment, illustrated for example in FIGS. 6A and 6B, the loudspeaker 1 comprises an additional coil 301C; thus, the coil 301C is wound around the central core 301A of the first half-shell, while the additional coil 301C is wound around the central core 301A of the second half-shell. The two half-shells are separate from each other to define the gap T.

In an example, the two half-shells, in conjunction with the lateral portion 301Ab of the central core 301A, define an indentation which constitutes a zone having high magnetic permeability.

The loudspeaker 1 comprises a magnet 302 or a plurality of magnets 302.

For example, as illustrated in FIGS. 6A and 6B, the loudspeaker 1 comprises only one magnet 302, located inside the gap T, between the first half-shell and the second half-shell. The magnet 302 extends along a plane which is perpendicular to the longitudinal axis. The magnet 302 is interposed between the coil 301C and the additional coil 301C along the longitudinal axis X. The magnet 302 is configured to move inside the gap T along a movement direction M. In the example of FIGS. 6A and 6B, the movement direction M is perpendicular to the longitudinal axis X.

For example, as illustrated in FIG. 2, the loudspeaker 1 comprises a plurality of magnets 302. In particular, the magnets of the plurality of magnets 302 are located in the gap T defined by the central core 301A and the outer core 301B. In this case, the gap T extends along a direction parallel to the longitudinal axis X. The magnets 302 extend along a plane which is perpendicular to the longitudinal axis X. In this case, the movement direction M of the magnets 302 is parallel to the longitudinal axis X.

The coil 301C may comprise a plurality of rectilinear portions joined to each other by curvilinear portions. The rectilinear portions of the coil 301C face each other and are disposed symmetrically about the longitudinal axis X so as to define a quadrilateral. The outer core 301B comprises a plurality of outer portions; preferably, the outer portions of the plurality of outer portions of the outer core 301B are separate from each other. When the loudspeaker 1 comprises a plurality of magnets 302, these are disposed relative to each other to form a quadrilateral, inside the gap, between the rectilinear portions of the coil 301C and the outer portions of the outer core 301B.

In particular, in the embodiment in which the movement direction M is parallel to the longitudinal axis X, each magnet 302 extends along a plane which is parallel to the longitudinal axis X and has a first face opposite the second face, where the first face and the second face lie in a plane which is parallel to the longitudinal axis X; the first face and the second face have opposite polarity. That way, when the magnets 302 located in the gap T are traversed by the alternating magnetic field generated by the coil 301C along the longitudinal direction, each magnet 302 moves with reciprocating motion along the movement direction M, parallel to the longitudinal direction.

In particular, in the embodiment in which the movement direction M is perpendicular to the longitudinal axis X, each magnet 302 extends along a plane which is perpendicular to the longitudinal axis X and has a first face opposite the second face, where the first face and the second face lie in a plane which is parallel to the longitudinal axis X; the first face and the second face each have a first section 302A and a second section 302A so that the first section 302A of the first face is located at the second section 302A of the second face, and the second section 302B of the first face is located at the first section 302A of the second face; the first section 302A and the second section 302B of each face have opposite polarity. The magnet 302 may also be considered as a pair of magnets 302, each having a first section 302A (defining a first face) and a second section 302B (defining a second face), where the first section 302A and the second section 302B have opposite polarity. The two magnets 302 of the pair are aligned with each other along the movement direction M so that the first section 302A of the first magnet 302 is aligned with the second section 302B of the second magnet 302 and the second section 302B of the first magnet 302 is aligned with the first section 302A of the second magnet 302 along the movement direction. Thus, the polarization of the first magnet 302 of the pair is orthogonal to the movement direction and directed in the sense opposite that of the second magnet 302 of the pair.

That way, when the magnet 302 (or the pair of magnets 302) located in the gap T is traversed by the alternating magnetic field generated by the coil 301C and the additional coil 301C along the longitudinal direction, the magnet 302 moves with reciprocating motion along the movement direction M, perpendicular to the longitudinal direction.

The loudspeaker 1 comprises a radiator which is operatively coupled to the magnet 302 or to the plurality of magnets 302 so as to move along the movement direction M to generate pressure waves.

The loudspeaker 1 comprises a guide system, comprising a plurality of flexible parts 60. Each flexible part 60 includes a first, upper connecting zone 60a′, a second, lower connecting zone 60a″ and a second connecting zone 60b. Each flexible part 60 comprises a plurality of joints and a plurality of rigid connecting portions.

In an embodiment, each flexible part 60 includes a first joint 601, a second joint 602, a third joint 603, a fourth joint 604 and a fifth joint 605, and a first rigid connecting portion 611, a second rigid connecting portion 612 and a third rigid connecting portion 613.

The first rigid connecting portion 611 extends transversely to the movement direction M between the first joint 601 and the fourth joint 604, the second rigid connecting portion 612 extends transversely to the movement direction M between the fifth 605 and the second joint 602. The third rigid connecting portion 613 is interposed between the first rigid connecting portion 611 and the second rigid connecting portion 612; in particular, the third rigid connecting portion 613 is connected to the first rigid connecting portion 611 at the fourth joint 604 and to the second rigid connecting portion 612 at the fifth joint 605. The first joint 601 is located in proximity to the upper connecting zone 60a′ and the second joint 602 is located in proximity to the lower connecting zone 60a″. The third joint 603 is located in proximity to the second connecting zone 60b.

The flexible part 60 is connected to the magnet 302 at the upper connecting zone 60a′ and at the lower connecting zone 60a″; thus, the first rigid connecting zone 611 is connected to the magnet 302 by the upper connecting zone 60a′ and the second rigid connecting zone 612 is connected to the magnet 302 by the lower connecting zone 60a″. The third rigid connecting zone 613 is connected to the outer core 301B of the ferromagnetic circuit at the second connecting point 60b.

In particular, each magnet 302 extends between a first end and a second end along an axis perpendicular to the movement direction M. Thus, each flexible part 60 is connected to the magnet 302 at the first end and at the second end of the magnet 302.

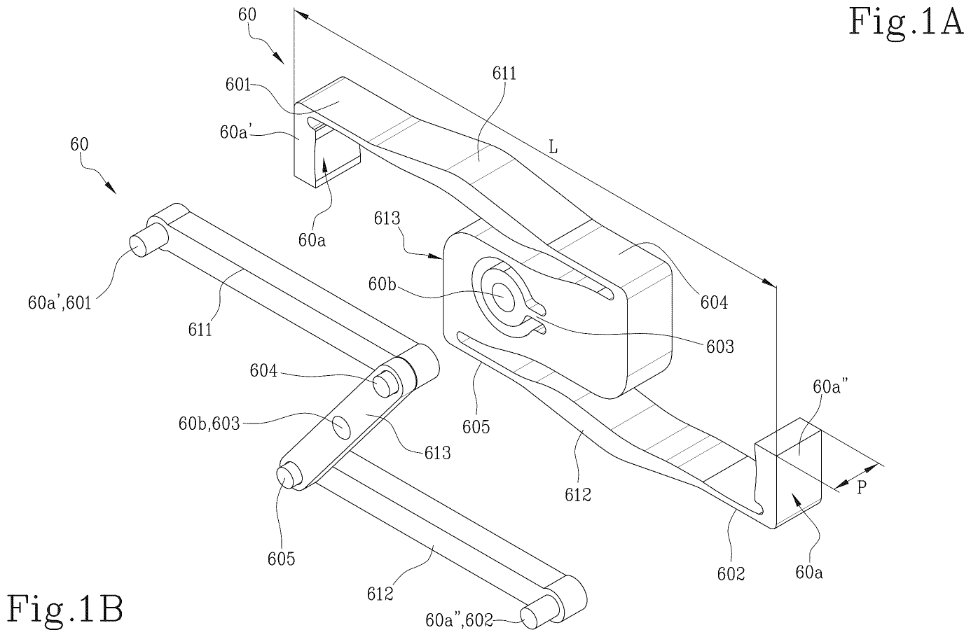

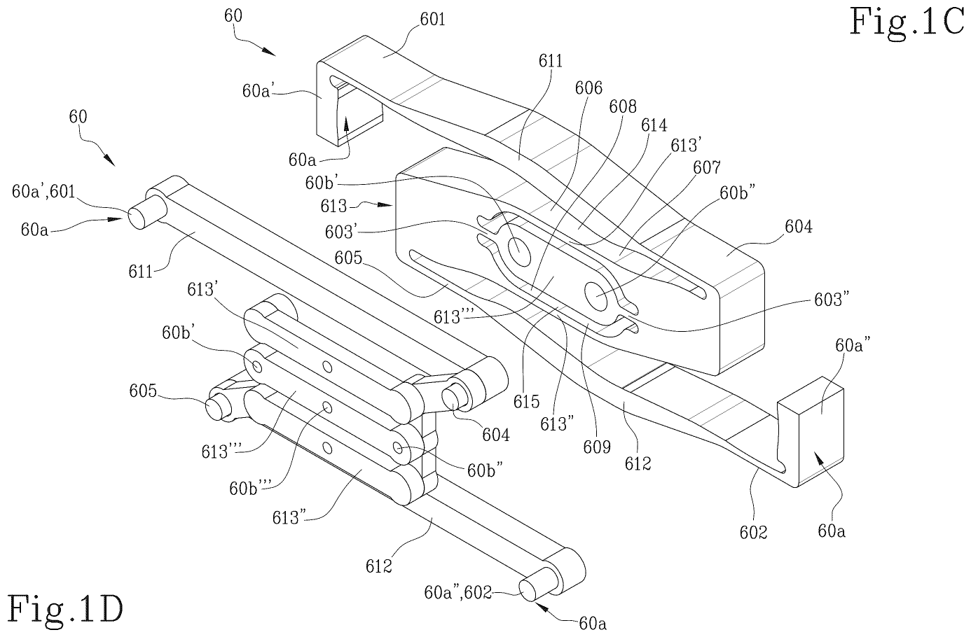

In an embodiment, illustrated solely for exemplary purposes in FIG. 1C, the third rigid connecting portion 613 comprises a first arm 613′, a second arm 613″ and a central portion 613′″, each extending transversely to the movement direction M and disposed parallel to each other, where the central portion 613″′ is interposed between the first arm 613′ and the second arm 613″. The first arm 613′ comprises a sixth joint 606, a seventh joint 607 and a fourth rigid connecting portion 614, interposed between the sixth joint 606 and the seventh joint 607. The second arm 613″ comprises an eighth joint 608, a ninth joint 609 and a fifth rigid connecting portion 615, interposed between the eighth joint 608 and the ninth joint 609. The third joint 603 comprises a pair of joints 603′ and 603″ and the second connecting zone 60b comprises a pair of connecting zones 60b′ and 60b″, where the pair of connecting zones 60b′ and 60b″ is interposed between the pair of joints 603′ and 603″. The central portion 613″′ is connected to the first arm 613′ and to the second arm 613″ at the pair of joints 603′ and 603″ and is connected to the outer core 301B at the pair of connecting zones 60b′ and 60b″. In an example, the second connecting zone 60b comprises an additional connecting zone 60b′″. The third rigid connecting portion comprises a slit or a plurality of slits. The slits are interposed between the first arm 613′ and the central portion 613′″ and between the second arm 613″ and the central portion 613′″.

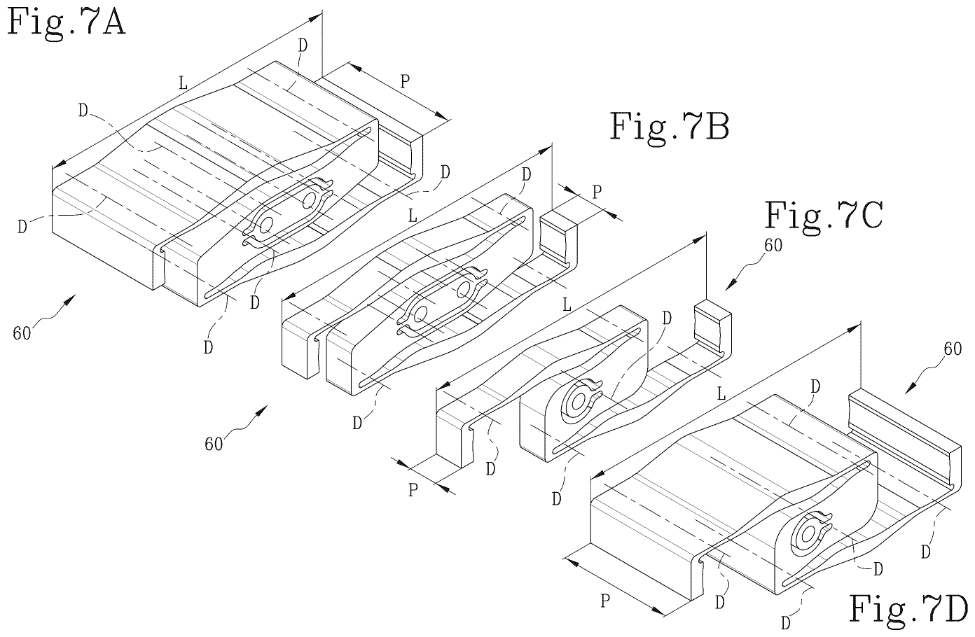

The flexible part 60 is configured to deform at the plurality of joints, around a corresponding plurality of deformation axes D. The deformation axes D of the joints are represented, for example, in FIG. 7. FIG. 7 also shows possible embodiments of a flexible part 60 which differ essentially in the ratio between the depth P and the width L.

In an embodiment, illustrated solely by way of example in FIG. 2, each flexible part 60 is connected to a magnet 302 of the plurality of magnets. In an embodiment, illustrated solely by way of example in FIGS. 6A and 6B, each flexible part 60 is connected to the magnet 302. Generally speaking, the flexible parts 60 are connected to the magnets 302 or to the magnet 302 by a support structure 62 configured to move along the movement direction M. The support structure 62 is connected to the flexible part 60 at the upper connecting zone 60a′ and at the lower connecting zone 60a″.

In an embodiment, illustrated solely by way of example in FIGS. 6A and 6B, the support structure 62 comprises a first supporting member 621 and a second supporting member 622. The first supporting member 621 and the second supporting member 622 are U-shaped, that is to say, they each comprise a pair of lateral elements and a transverse element interposed between the lateral elements to define the U shape. The lateral elements extend along parallel planes and the transverse element extends along a plane which is transverse to the planes along which the lateral elements extend. The lateral elements are connected to the flexible parts 60. The transverse element of the first supporting member 621 and of the second supporting member 622 together define a housing configured to accommodate the magnet 302. Thus, the support structure 62 moves as one with the magnet 302 and transmits the movement to the flexible parts 60, which deform at the plurality of joints.

In an embodiment, illustrated solely by way of example in FIG. 2, the support structure 62 comprises a plurality of corner elements 630. Each corner element 630 is configured to connect the magnets 302 to each other in pairs and to connect the magnets 302 to the flexible parts 60. In particular, each corner element 630 is configured to connect two adjacent flexible parts 60 at the upper connecting zone 60a′ and lower connecting zone 60a″. That way, the plurality of magnets 302 forms a quadrilateral and the plurality of flexible parts 60 forms a quadrilateral surrounding the magnets 302. Interposed between the magnets 302 and the flexible parts 60 are the outer portions of the outer core 301B, to which the flexible parts 60 are connected by the second connecting point 60b. When the magnets 302 move along the movement direction M responsive to the magnetic field generated by the coil 301C, the corner elements 630 move together with the magnets 302 and the flexible parts 60 deform at the plurality of joints.

FIGS. 1B and 1D show simplified representations of the flexible parts 60 of FIGS. 1A and 1C, respectively. In particular, it is noted that the flexible part 60 of FIGS. 1A and 1C may be approximated to the flexible part 60 of FIGS. 1B and 1D, respectively, where the deformable joints are replaced by pins, around which the flexible part 60 rotates following the relative movements of the rigid connecting portions.

In an embodiment, the loudspeaker 1 comprises a plurality of actuating parts 401 configured to connect the magnets 302 to the radiator, so that a movement of the magnets 302 corresponds to a movement of the radiator along the same direction in the opposite sense. In particular, the support structure 62 (specifically the corner elements 630) connects each actuating part 401 to the respective magnet 302. Each actuating part 401 may comprise a thin plate 402 embedded in the actuating part 401 and configured to increase its stiffness. The thin plate 402 may be a punch formed plate.

For a more detailed description of the actuating parts 401, refer to patent document 102021000032906, in the name of the present Applicant and incorporated herein by reference.

The loudspeaker 1 comprises a first half-shell 7a and a second half-shell 7b; enclosed between the first half-shell 7a and the second half-shell 7b are the coil 301C (and the additional coil 301C), the ferromagnetic circuit and the magnet 302 (of the plurality of magnets 302).

| | |
|---|---|
| 1 | Loudspeaker |
| X | Longitudinal axis X |
| 301A | Central core |
| 301Aa | Central portion of 301A |
| 301Ab | Outer portion of 301A |
| 301B | Outer core |
| 301C | Coil |
| 302 | Magnet |
| 302A | First section |
| 302B | Second section |
| 401 | Actuating part |
| 402 | Thin plate |
| 60 | Flexible part |
| 60a | First connecting zone |
| 60a′ | Upper connecting zone |
| 60a″ | Lower connecting zone |
| 60b | Second connecting zone |
| 60b′, | Pair of connecting zones |
| 60b″ | |
| 60b″′ | Additional second connecting zone |
| 601 | First joint |
| 602 | Second joint |
| 603 | Third joint |
| 603′, | Pair of joints |
| 603″ | |
| 604 | Fourth joint |
| 605 | Fifth joint |
| 606 | Sixth joint |
| 607 | Seventh joint |
| 608 | Eighth joint |
| 609 | Ninth joint |
| 611 | First rigid connecting zone |
| 612 | Second rigid connecting zone |
| 613 | Third rigid connecting zone |
| 614 | Fourth rigid connecting zone |
| 615 | Fifth rigid connecting zone |
| 62 | Support structure |
| 621 | First supporting member |
| 622 | Second supporting member |
| 630 | Corner elements |
| 7a, | Half-shells |
| 7b | |

1. A loudspeaker, comprising:
a coil, configured to generate a magnetic field along a longitudinal axis;
a ferromagnetic circuit, including
a central core around which the coil is wound, and
an outer core located at the side of the coil and at least partly surrounding the coil, the outer core being separate from the central core so as to define a gap, wherein the coil and the ferromagnetic circuit constitute a fixed working unit;
a magnet, located in the gap and movable inside the gap along a movement direction responsive to the magnetic field generated by the coil, the gap extending along the movement direction;
a radiator, operatively coupled to the magnet so that a movement of the magnet along the respective movement direction corresponds to an oscillation of the radiator to generate pressure waves, wherein the magnet and the radiator constitute a movable working unit;
a guide system, configured to constrain the magnet to move along the movement direction,
wherein the guide system includes a flexible part constituting a compliant mechanism, connected to the movable working unit in a first connecting zone and to the fixed working unit in a second connecting zone, the flexible part having a plurality of deformable joints and a plurality of rigid connecting portions, the deformable joints being interposed between the rigid connecting portions so as to guide the magnet along the movement direction by elastically deforming the flexible part.

2. The loudspeaker according to claim 1, comprising a plurality of magnets, wherein:
the plurality of magnets comprises the magnet;
each magnet of the plurality of magnets is movable along a respective movement direction and is connected to the radiator so as to define, together with the radiator, the movable working unit of the loudspeaker;
for each magnet of the plurality of magnets, the guide system comprises a flexible part, connected to the respective magnet in the first connecting zone and to the fixed working unit in the second connecting zone and configured to guide the magnet of the plurality of magnets along the respective movement direction.

3. The loudspeaker according to claim 1, wherein the flexible part is made of acetal resin.

4. The loudspeaker according to claim 1, wherein the plurality of joints is configured to create a mechanism which approximates a Watt linear rail.

5. The loudspeaker according to claim 1, wherein:
the first connecting zone includes an upper connecting zone and a lower connecting zone;
the plurality of joints comprises a first joint, a second joint, a third joint, a fourth joint and a fifth joint;
the plurality of rigid connecting portions comprises a first rigid connecting portion, a second rigid connecting portion and a third rigid connecting portion,
the first joint is located in proximity to the upper connecting zone, the second joint is located in proximity to the lower connecting zone and the third joint is located in proximity to the second connecting zone;
the first rigid connecting portion extends transversely to the movement direction between the first joint and the fourth joint, the second rigid connecting portion extends transversely to the movement direction between the second joint and the fifth joint;
the third rigid connecting portion is connected to the first rigid connecting portion at the fourth joint, to the second rigid connecting portion at the fifth joint, the third rigid connecting portion being connected by the second connecting point to the fixed working unit of the loudspeaker.

6. The loudspeaker according to claim 5, wherein the flexible part has a width, defined at the upper connecting zone and at the lower connecting zone perpendicularly to the movement direction, and a depth, defined perpendicularly to the movement direction and to the width, and wherein a ratio between the width and the depth is greater than 2.

7. The loudspeaker according to claim 6, wherein the ratio between the width and the depth is less than 12.

8. The loudspeaker according to claim 5, wherein the third rigid connecting portion comprises a plurality of arms, each of the arms extending transversely to the movement direction so as to allow the third rigid connecting zone to deform along the movement direction responsive to the movement of the magnet along the movement direction.

9. The loudspeaker according to claim 8, wherein the plurality of arms comprises a first arm and a second arm connected to each other at their ends, wherein:
the first arm comprises a sixth joint, a seventh joint and a fourth rigid connecting portion, interposed between the sixth joint and the seventh joint;
the second arm comprises an eighth joint, a ninth joint and a fifth rigid connecting portion, interposed between the eighth joint and the ninth joint, the first arm and the second arm being configured to deform at the sixth joint, the seventh joint, the eighth joint and the ninth joint responsive to the magnet moving along the movement direction.

10. The loudspeaker according to claim 9, wherein:
the second connecting zone comprises a pair of connecting zones;
the third joint comprises a pair of joints, wherein the pair of connecting zones is interposed between the joints of the pair of joints;
the third rigid connecting portion comprises a central portion connected to the fixed working unit of the loudspeaker in the pair of connecting zones and movable relative to the first arm and the second arm by deforming the pair of joints.

11. The loudspeaker according to claim 5, wherein the guiding device includes a support structure configured to connect the magnet to the first rigid connecting portion and to the second rigid connecting portion, the support structure being movable along the movement direction responsive to the magnet moving along the movement direction.

12. The loudspeaker according to claim 11, comprising an actuating part configured to connect the magnet to the radiator, so that a movement of the magnet along the movement direction, corresponds to a movement of the radiator in the opposite direction, the actuating part being connected to the magnet by the support structure.

13. A linear actuator, comprising
a coil, configured to generate a magnetic field along a longitudinal axis;
a ferromagnetic circuit, including
a central core around which the coil is wound, and
an outer core located at the side of the coil and at least partly surrounding the coil, the outer core being separate from the central core so as to define a gap, wherein the coil and the ferromagnetic circuit constitute a fixed working unit;
a magnet, located in the gap and movable inside the gap along a movement direction responsive to the magnetic field generated by the coil, the gap extending along the movement direction (M), the magnet constituting a movable working unit;
a guide system, configured to constrain the magnet to move along the movement direction,
wherein the guide system includes a flexible part constituting a compliant mechanism, connected to the movable working unit in a first connecting zone and to the fixed working unit in a second connecting zone, the flexible part having a plurality of deformable joints and a plurality of rigid connecting portions, the deformable joints being interposed between the rigid connecting portions so as to guide the magnet along the movement direction by elastically deforming the flexible part.

14. A method for spreading a sound, comprising the following steps:
providing a coil and a ferromagnetic circuit, including
a central core around which the coil is wound, and
an outer core located at the side of the coil and at least partly surrounding the coil, the outer core being separate from the core so as to define a gap, wherein the coil and the ferromagnetic circuit constitute a fixed working unit;
providing a magnet, located in the gap, and a radiator operatively coupled to the magnet, wherein the magnet and the radiator constitute a movable working unit;
generating a magnetic field along a longitudinal axis via the coil;
moving the magnet in the gap along the movement direction responsive to the magnetic field generated;
swinging the radiator along the movement direction responsive to the movement of the magnet so as to generate pressure waves
guiding the movement of the magnet along the movement direction via a guide system,
wherein the guide system includes a flexible part constituting a compliant mechanism, connected to the movable working unit in a first connecting zone and to the fixed working unit in a second connecting zone, the flexible part having a plurality of deformable joints and a plurality of rigid connecting portions, the deformable joints being interposed between the rigid connecting portions, wherein the step of guiding the magnet along the movement direction is carried out by the flexible part by elastic deformation of the flexible part.

15. The method according to claim 14, wherein the step of providing the magnet includes providing a plurality of magnets and wherein:
the plurality of magnets comprises the magnet;
each magnet of the plurality of magnets is movable along a respective movement direction and is connected to the radiator to define, together with the radiator, the movable working unit of the loudspeaker;
for each magnet of the plurality of magnets, the guide system comprises a flexible part, connected to the respective magnet in the first connecting zone and to the fixed working unit in the second connecting zone,
the method comprising a step of moving each magnet along the respective movement direction, the step of guiding including a step of guiding the movement of the respective magnet along the movement direction via the respective flexible part.

16. The method according to claim 14, wherein:
the first connecting zone includes an upper connecting zone and a lower connecting zone;
the plurality of joints comprises a first joint, a second joint, a third joint, a fourth joint and a fifth joint;
the plurality of rigid connecting portions comprises a first rigid connecting portion, a second rigid connecting portion and a third rigid connecting portion,
the first joint is located in proximity to the upper connecting zone, the second joint is located in proximity to the lower connecting zone and the third joint is located in proximity to the second connecting zone;
the first rigid connecting portion extends transversely to the movement direction between the first joint and the fourth joint, the second rigid connecting portion extends transversely to the movement direction between the second joint and the fifth joint;
the third rigid connecting portion is connected to the first rigid connecting portion at the fourth joint, to the second rigid connecting portion at the fifth joint, the third rigid connecting portion being connected by the second connecting point to the fixed working unit of the loudspeaker.

17. The method according to claim 16, wherein:
the third rigid connecting portion comprises a plurality of arms, each of the arms extending transversely to the movement direction, the plurality of arms comprising a first arm and a second arm connected to each other at their ends;
the first arm comprises a sixth joint, a seventh joint and a fourth rigid connecting portion (614), interposed between the sixth joint and the seventh joint;
the second arm comprises an eighth joint, a ninth joint and a fifth rigid connecting portion, interposed between the eighth joint and the ninth joint,
the second connecting zone comprises a pair of connecting zones;
the third joint comprises a pair of joints, wherein the pair of connecting zones is interposed between the joints of the pair of joints;
the third rigid connecting portion comprises a central portion connected to the fixed working unit of the loudspeaker in the pair of connecting zones and movable relative to the first arm and the second arm by deforming the pair of joints,
wherein, in the step of guiding, the first arm and the second arm deform at the sixth joint, the seventh joint, the eighth joint (608) and the ninth joint and the central portion deforms at the pair of joints responsive to the magnet moving along the movement direction.

18. The method according to claim 16, wherein the guiding device includes a support structure configured to connect the magnet to the first rigid connecting portion and to the second rigid connecting portion, and wherein, in the step of guiding, the support structure moves along the movement direction responsive to the magnet moving along the movement direction.

19. The loudspeaker according to claim 1, wherein the rigid connecting portions have a main extension along a transverse direction, the transverse direction being transverse to the direction of movement, the guide system being configured for preventing the movement of the magnet along said transverse direction.

20. The loudspeaker according to claim 19, wherein
the rigid connecting portions of the flexible part have:
a width defined along a first transverse direction, the first transverse direction being perpendicular to the direction of movement of the magnet, and
a depth defined along a second transverse direction, the second transverse direction being perpendicular to the direction of movement of the magnet and to the first transverse direction, p1 the loudspeaker has a transverse dimension defined along the first transverse direction,
the width of the rigid connecting portion being substantially equal to the transverse dimension of the loudspeaker.
